(19) United States
(12) Patent Application Publication
(10) Pub. No.: US 2017/0358024 A1
(43) Pub. Date: Dec. 14, 2017

(54) VIRTUAL REALITY SHOPPING SYSTEMS AND METHODS

(71) Applicant: Wal-Mart Stores, Inc., Bentonville, AR (US)

(72) Inventors: Todd D. Mattingly, Bentonville, AR (US); Robert J. Taylor, Rogers, AR (US); David Tovey, Rogers, AR (US); John J. O'Brien, Farmington, AR (US); Donald R. High, Noel, MO (US)

(21) Appl. No.: 15/620,006

(22) Filed: Jun. 12, 2017

Related U.S. Application Data
(60) Provisional application No. 62/349,303, filed on Jun. 13, 2016.

(51) Int. Cl. G06Q 30/06; G06F 3/0481; G06Q 20/20; G06F 21/31; G06F 3/041; G06T 19/00

(52) U.S. Cl. CPC G06Q 30/0643; G06F 3/041; G06T 19/006; G06T 19/003; G06Q 20/204; G06F 21/31; G06F 3/04815; G10K 2210/108

(57) ABSTRACT

In some embodiments, apparatuses, and methods are provided herein useful to providing a virtual shopping system. A system for providing a virtual shopping experience comprises: a central computer system, a virtual reality showroom system in communication with the central computer system, the virtual reality showroom portion comprising one or more virtual reality shopping stations, each of the virtual reality shopping stations comprising a display device extending around at least a portion of a user, and configured to present a virtual representation of a shopping space for user navigation, and a user input device, wherein the user input device is configured to allow the user to navigate the virtual representation of the shopping space, a point of sale system in communication with the central computer system, and a fulfillment portion in communication with the central computer system and configured to facilitate transfer of purchased items to the user.

### CROSS-REFERENCE TO RELATED APPLICATION

This application claims the benefit of U.S. Provisional Application No. 62/349,303, filed Jun. 13, 2016, which is incorporated herein by reference in its entirety.

### TECHNICAL FIELD

This invention relates generally to virtual reality systems, and, more particularly, to virtual reality shopping systems.

### BACKGROUND

Currently, customers can either shop online or visit a shopping facility to inspect and purchase goods and services. Some shoppers do not like shopping online or would prefer to visit a shopping facility so that they can inspect the products more carefully. Visiting a shopping facility can be time consuming and difficult for some shoppers. Not only do shoppers have to find time to visit a shopping facility, they also have to wait in line and contend with crowds. Furthermore, a shopping facility may not have the product in stock that a shopper wants to inspect and/or purchase. Additionally, from the shopping facility's perspective, it can be difficult and expensive to maintain an inventory of all products. It is also expensive to maintain and staff shopping facilities.

### BRIEF DESCRIPTION OF THE DRAWINGS

Disclosed herein are embodiments of systems, apparatuses and methods pertaining to a virtual reality shopping experience. This description includes drawings, wherein:

FIG. 1 depicts an example virtual reality shopping station 100, according to some embodiments.

FIG. 2 depicts an example virtual reality shopping system 200, according to some embodiments.

FIG. 3 is a flow diagram depicting example operations for providing a virtual shopping experience, according to some embodiments.

Elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. Certain actions and/or steps may be described or depicted in a particular order of occurrence while those skilled in the art will understand that such specificity with respect to sequence is not actually required. The terms and expressions used herein have the ordinary technical meaning as is accorded to such terms and expressions by persons skilled in the technical field as set forth above except where different specific meanings have otherwise been set forth herein.

### DETAILED DESCRIPTION

Generally speaking, pursuant to various embodiments, systems, apparatuses, and methods are provided herein useful to providing a virtual shopping experience. In some embodiments, a virtual reality shopping system includes a central computer system, a point of sale system in communication with the central computer system, a fulfillment portion in communication with the central computer system and configured to facilitate transfer of purchased items to the user, and a virtual reality showroom system in communication with the central computer system, the virtual reality showroom comprising one or more virtual reality shopping stations, each of the one or more virtual reality shopping stations comprising a display device extending around a least a portion of a user, wherein the display device is configured to present a virtual representation of a shopping space for user navigation, and a user input device, wherein the user input device is configured to allow the user to navigate the virtual representation of the shopping space.

As previously discussed, some shoppers may not like shopping online and some shoppers may find it difficult to find time to visit a shopping facility. Unfortunately, shoppers are currently left with few alternatives to online shopping or visiting a shopping facility. Additionally, the alternatives that exist (e.g., a personal shopping services) have drawbacks as well, such as cost, inability to personally inspect items, etc. Consequently, a need exists for a shopping experience that removes or minimizes the drawbacks of traditional shopping experiences. In some embodiments, a virtual shopping system is described that can eliminate and/or reduce some or all of these drawbacks.

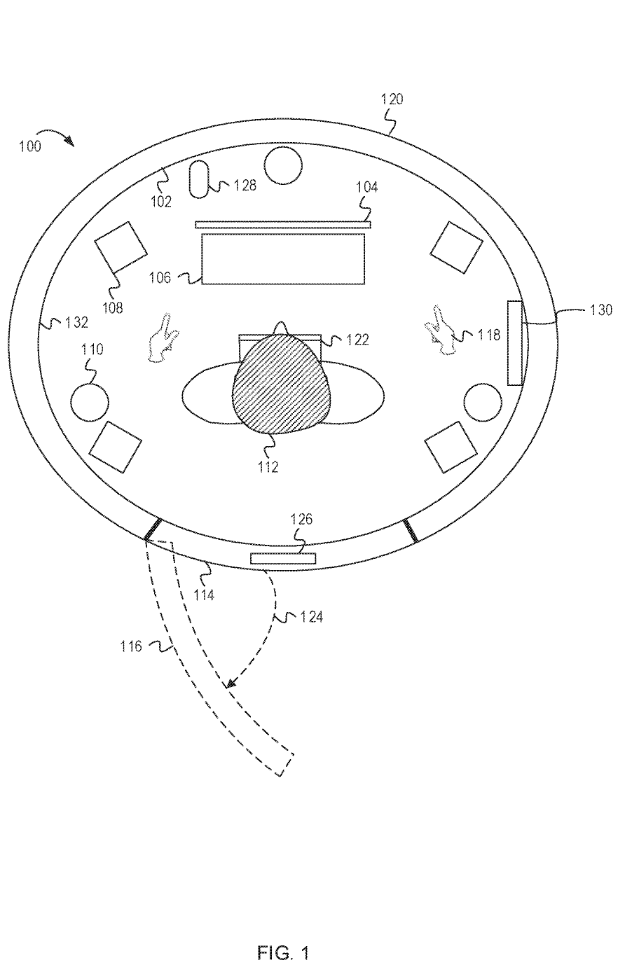

FIG. 1 depicts a virtual reality shopping station 100, according to some embodiments. The virtual reality shopping station 100 consists of a room 120 or other area in which the components of the virtual reality shopping station 100 are located. The components of the virtual reality shopping station 100 includes a display device 102, a holographic display 104, a primary input device 106, audio devices 108, motion sensors 110, an authentication device 126, and a payment device 130. The virtual reality shopping station 100 may surround the user (as depicted in FIG. 1) or may only partially surround the user. If the virtual reality shopping station 100 surrounds the user, the virtual reality shopping station 100 can include a door 114, or other means for entering and exiting the virtual reality shopping station 100. As an example, the door 114 can open to an opened position (as indicated by hashed door 116 and the arrow 124) to provide a user 112 access to the virtual reality shopping station 100. The virtual reality shopping station 100 can be located at or near a shopping facility (e.g., a virtual reality shopping station 100 for Store A can be located at or near Store A), at or near a different facility (e.g., at or near a gas station, a bank, an office building, etc.), or in a standalone facility (e.g., in a location designated for virtual reality shopping stations 100). Additionally, the virtual reality shopping station 100 can be associated with a specific brand or store (e.g., the virtual reality shopping station may carry only items from a single brand or retailer), associated with multiple brands or stores, associated with a specific type of good or service, be based on a sponsored status (i.e., the user 112 can shop for any goods or services from sponsoring brands or retailers), or be generic (e.g., like traditional online shopping, so the user 112 can view products from any brand or retailer that supports the virtual reality shopping station 100).

In some embodiments, the virtual reality shopping station 100 can include both virtual reality and augmented reality aspects, although for simplicity both aspects will simply be referred to as “virtual reality” in the context of this application. For example, the display device 102 can present a virtual reality environment and the user 112 can utilize glasses 122 to view and/or manipulate virtual products that appear to be in the user's 112 hands. The glasses 122 can be virtual reality glasses/goggles or augmented reality glasses/goggles. Additionally, the user 112 can utilize haptic gloves 118 (or other haptic devices, such as mats, sheets, objects, wearables, etc.) that simulate tactile sensations for products. In some embodiments, the holographic display 104 presents products for the user to view and/or manipulate. The user 112 interacts with the virtual reality shopping station 100 via the primary input device 106. The primary input device 106 can be a touchscreen, a touchpad, a keyboard, a mouse, or any other suitable input device or combination of input devices. The user 112 can also interact with the virtual reality shopping station 100 via input devices in addition to the primary input device 106. For example, the motion sensors 110 can detect the user's 112 movement within the virtual reality shopping station 100 and reorient images presented on the display device 102 in a manner which is consistent with the user's 112 movements. The motion sensors 110 can also be used to allow the user 112 to provide input via hand gestures. The motion sensors 110 can also include specialized motion sensors that, for example, track the user's 112 eye movements. Such specialized sensors can allow the user to provide input to the virtual reality shopping station via eye movement or track the user's 112 eye movement to determine what presentations or objects within the virtual reality shopping station 100 catch the user's 112 attention. In some embodiments, the user 112 can also use his/her own devices (e.g., a mobile device) as an input device. Additionally, the virtual reality shopping station 100 can include one or more microphones 128. The microphones 128 can act as an input device to allow the user 112 to provide voice commands to the virtual reality shopping station 100. Additionally, or alternatively, the microphones 128 can monitor audio within the virtual reality shopping station to gather data and/or information about the user 112. The data and/or information can be used to improve the user's 112 shopping experience, target marketing and/advertisements to the user, build a database of information about the user, etc.

The display device 102 presents a virtual representation of a shopping space. For example, the virtual representation of the shopping space can resemble a virtual shopping facility (e.g., a brick-and-mortar shopping facility having aisles, simulated customers or other customers that are currently shopping virtually, and simulated salespersons), a virtual shopping center lacking other customers or distractions, an environment consistent with products for which the user 112 is shopping, an environment specified by the user 112 (e.g., based on preferences of the user 112), images or branding that is specific to the products for which the user 112 is shopping, images or branding that is specific to the types of products for which the user 112 is shopping, a virtual mall or shopping center through which the user 112 can navigate to virtual storefronts, or any other suitable imagery. The user 112 can also choose to shop with friends and/or family. For example, virtual depictions of friends and/or family members in other virtual reality shopping stations can be presented on the display device 102. In some embodiments, the display device 102 extends at least partially around the user. For example, the display device 102 can extend 270 degrees around the user 112. This however is not required. For example, the display device 102 can extend around the user 112 to a greater or lesser extent. Alternatively, the display device 102 can be flat (i.e., exist in a single plane). The display device 102 can also present information (e.g., statistics, prices, reviews, suggestions, availability, anticipated delivery dates, alternatives, advertising, videos, etc.) about products which the user 112 is viewing and/or for which the user is shopping and the imagery presented by the display device 102 can be controlled by the user. In this regard the space available to present information about the product is not limited to the size of the product or the size of the product's packaging.

The virtual reality shopping station 100 can also include one or more audio devices 108. The audio devices 108 can enhance the user's 112 shopping experience by presenting audio to the user 112. The audio can be any suitable audio, such a recordings of audio in a shopping facility, simulated audio in a shopping facility, music (whether selected by the user 112 or some other party), advertisements, information about products which the user 112 is viewing and/or for which the user 112 is shopping, etc.

In some embodiments, the virtual reality shopping station 100 can include one or more authentication devices 126. The authentication device 126 can restrict access to the virtual reality shopping station 100 to customers. Additionally, the authentication device 126 can be used to identify a user and/or configure the virtual reality shopping station 100 in a manner consistent with the user's 112 preferences. For example, the virtual reality shopping station 100 can load the user's 112 profile, payment options, addresses, recently viewed items, saved items, display preferences, etc. In this regard, the authentication device 126 can also identify the user's history and demographic information. This information can be used to better tailor the virtual reality shopping station 100 for the user 112. This information can also be used for research, analytics, marketing, and advertising purposes. In some embodiments, the authentication device 126 may not identify individual shoppers. The authentication device 126 can take any suitable form. For example, the authentication device 126 can be a credit card reader, an identification reader, one or more biometric sensors, an input device with which the user 112 can input his/her credentials (e.g., a username and password) or any other identifying information, etc. In some embodiments, the authentication device 126 and the payment device 130 can be a single device (i.e., the authentication device 126 can double as the payment device 130).

Additionally, in some embodiments, the virtual reality shopping station 100 can include privacy features, such as noise cancellation or suppression devices and/or video cancellation or suppression devices. For example, the virtual shopping station 100 can include passive noise cancellation, such as sound deadening material 132. Additionally, or alternatively, the virtual reality shopping station 100 can include active noise cancellation features. Such active noise cancellation features can utilize the microphones 128 and the audio devices 108. For example, the audio devices 108 can present audio that cancels out the audio perceived by the microphones 128. As to the video cancellation or suppression devices, the virtual reality shipping station 100 can include filters (e.g., polarized filters) covering the display device 102 or shields that cover or obscure images presented on the display device 102.

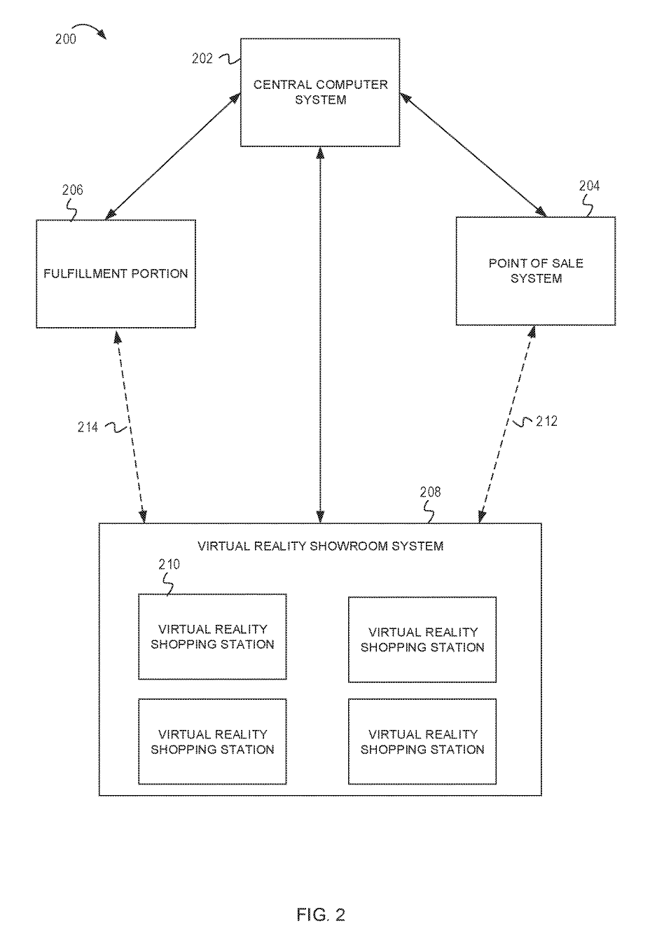

While FIG. 1 and the related text describe an example virtual reality shopping station, FIG. 2 and the related text describe an example virtual reality shopping system.

FIG. 2 depicts a virtual reality shopping system 200, according to some embodiments. The virtual reality shopping system 200 includes a central computer system 202, a point of sale system 204, a fulfillment portion 206, and a virtual reality showroom system 208. The virtual reality showroom system 208 includes one or more virtual reality shopping stations 210. The virtual reality shopping stations 210 can be similar to those depicted in FIG. 1 or be of any other suitable variety. The virtual reality showroom system 208 can be located at a single location (i.e., all of the virtual reality shopping stations 210 are located at a single location) or the virtual reality showroom system 208 can be distributed across multiple locations (i.e., the virtual reality shopping stations 210 are located at multiple locations). The virtual reality shopping stations 210 can be located at a shopping facility, in an office building, in a mall, on a military base, etc. or any combination of the locations. In some embodiments, each virtual reality shopping station 210 in the virtual reality showroom system 208 can be associated with a single retailer. For example, all virtual reality shopping stations 210 in the virtual reality showroom system 208 can be associated with Store A. In other embodiments, some of the virtual reality shopping stations 210 can be associated with retailers that are different than a retailer associated with others of the virtual reality shopping stations 210. For example, two of the virtual reality shopping stations 210 can be associated with Store A and another one of the virtual reality shopping stations 210 can be associated with store B. As another example, some of the virtual reality shopping stations 210 can be associated with Store A and others of the virtual reality shopping stations 210 can be generic. The virtual reality shopping system 200 can also include multiple virtual reality showroom systems 208, as well as multiple fulfillment portions 206 and multiple point of sale systems 204.

Shoppers use the virtual reality shopping stations 210 to view and/or purchase goods and/or services. The virtual reality shopping stations 210 communicate with the central computer system 202. In some embodiments, the virtual reality showroom system 208 includes infrastructure (e.g., computer systems, communications networks, etc.) that supports the virtual reality shopping stations 210. For example, the virtual reality showroom system 208 can include the logic to generate virtual representations of shopping spaces and/or provide the virtual representations of shopping spaces to the virtual reality shopping stations 210. In such embodiments, the virtual reality shopping stations 210 can communicate with the central computer system 202 via the virtual reality showroom system 208. The virtual reality showroom system 208 can also conduct authentication functions for the virtual reality shopping stations 210. In such embodiments, the virtual reality showroom system can include a database of user information and/or credentials. In other embodiments, the central computer system 202 includes the logic to generate the virtual representations of shopping spaces and/or provides the virtual representations of shopping spaces to the virtual reality showroom system 208. The virtual reality showroom system 208 then provides the virtual representations of shopping spaces to the virtual reality shopping stations 210.

In some embodiments, the central computer system 202 receives user information and sales information from the virtual reality showroom system 208. The central computer system 202 communicates with the point of sale system 204 to facilitate purchase of products or items indicated by the sales information. The central computer system 202 can also communicate with the fulfillment portion 206 to facilitate transfer of the purchased products or items to the user. In some embodiments, the central computer system 202 can also perform authentication functions for the virtual reality shopping stations 210. In such embodiments, the central computer system 202 can include a database of user information and/or credentials.

The point of sale system 204 receives user information and sales information from the central computer system 202 (or, in some embodiments, from the virtual reality showroom system or virtual reality shopping stations 210, as indicated by the hashed arrow 212). The point of sale system 204 facilitates purchase of the products (i.e., goods or services purchased by the shoppers). In some embodiments, the point of sale system 204 includes a database of shopper identifications, payment methods, addresses, etc. In such embodiments, the point of sale system 204 processes the sales.

The fulfillment portion 206 facilitates transfer of purchased products to the shoppers. In some embodiments, the virtual reality showroom system 208 is located within or near a shopping facility or other location in which products are located (e.g., a warehouse or stockroom). In such embodiments, the fulfillment portion is local (i.e., physically local) to the virtual reality showroom system 208. In such embodiments the fulfillment portion 206 includes the necessary infrastructure to deliver the products to the shoppers. For example, the fulfillment portion 206 can include conveyor belts, autonomous vehicles, pulley systems, chute systems, a network of employees, etc. The fulfillment portion 206 can deliver the products directly to the shoppers or to a pickup area. In embodiments in which the fulfillment portion 206 delivers the products directly to the shoppers, the fulfillment portion 206 can deliver the products to the virtual reality shopping stations 210. In other embodiments, the virtual reality shopping stations are located remotely from a shopping facility or other location in which products are located. In such embodiments the fulfillment portion 206 facilitates delivery of the products to the shoppers. For example, the fulfillment portion 206 can arrange delivery of the products to the shopper's home or residence, the shopper's office, a locker, or any other location specified by the shopper. The fulfillment portion 206 can facilitate delivery via any suitable delivery agent. The fulfillment portion 206 can obtain shopper information (e.g., names, addresses, identification of the virtual reality shopping station 210, etc.) from the virtual reality showroom system 208 (as indicated by arrow 214), the point of sale system 204, or the central computer system 202.

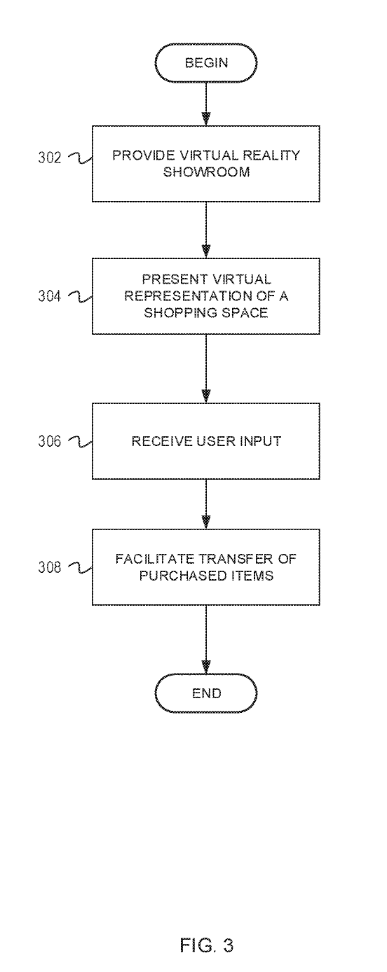

FIG. 3 is a flow diagram depicting example operations for providing a virtual shopping experience, according to some embodiments. The flow begins at block 302.

At block 302, a virtual reality showroom is provided. The virtual reality showroom includes one or more virtual reality shopping stations. The virtual reality shopping stations can be located in any suitable location, such a shopping facility, a mall or shopping center, an office building, a gas station or other type of service station, etc. Shoppers can use the virtual reality shopping stations to shop for goods and/or services. The flow continues at block 304.

At block 304, a virtual representation of a shopping space is presented. For example, the virtual reality shopping station can present the virtual representation of the shopping space. The virtual representation of the shopping space can resemble a shopping facility or include any suitable imagery. In some embodiments, the presentation of the virtual representation of the shopping space can surround at least a portion of a user. The flow continues at block 306.

At block 306, user input is received. For example, the user input can be received via one or more user input devices in the virtual reality shopping station. The user input devices can include touchscreens, touchpads, keyboards, mice, joysticks, motion sensors, microphones, or any other suitable input mechanism. The user interacts with the virtual reality shopping station via the one or more user input devices. The one or more input devices allow the user to navigate the virtual representation of the shopping space, interact with products, select products, purchase products, specify virtual reality shopping station preferences, specify payment preferences, specify delivery preferences, etc. The flow continues at block 308.

At block 308, transfer of purchased items is facilitated. For example, a fulfillment portion can facilitate transfer of purchased items to the user. The items can be goods and/or services purchased by the user. The fulfillment portion can facilitate delivery of the items directly to the virtual reality shopping station or facilitate delivery of the purchased items to a location specified by the user.

Those skilled in the art will recognize that a wide variety of other modifications, alterations, and combinations can also be made with respect to the above described embodiments without departing from the scope of the invention, and that such modifications, alterations, and combinations are to be viewed as being within the ambit of the inventive concept. For example, although the central computer system is depicted in FIG. 2 as separate from the point of sale system and the fulfillment portion, in some embodiments the central computer system includes the point of sale system and the fulfillment portion.

In some embodiments, a virtual reality shopping system includes a central computer system, a point of sale system in communication with the central computer system, a fulfillment portion in communication with the central computer system and configured to facilitate transfer of purchased items to the user, and a virtual reality showroom system in communication with the central computer system, the virtual reality showroom comprising one or more virtual reality shopping stations, each of the one or more virtual reality shopping stations comprising a display device extending around a least a portion of a user, wherein the display device is configured to present a virtual representation of a shopping space for user navigation, and a user input device, wherein the user input device is configured to allow the user to navigate the virtual representation of the shopping space.

In some embodiments, a method comprises providing a virtual reality showroom including one or more virtual reality shopping stations, wherein each of the one or more virtual reality shopping stations include a display device that extends around at least a portion of a user and a user input device, presenting, via the display device, a visual representation of a shopping space for user navigation, receiving, via the use input device, user input to allow the user to navigate the virtual representation of the shopping space, and facilitating, via a fulfillment portion, transfer of purchased items to the user.

What is claimed is:

1. A virtual reality shopping system comprising:
a central computer system;
a virtual reality showroom portion in communication with the central computer system, the virtual reality showroom portion comprising,
one or more virtual reality shopping stations, each of the one or more virtual reality shopping stations comprising,
a display device extending around at least a portion of a user, wherein the display device is configured to present a virtual representation of a shopping space for user navigation, and
a user input device, wherein the user input device is configured to allow the user to navigate the virtual representation of the shopping space,
a point of sale system in communication with the central computer system; and
a fulfillment portion in communication with the central computer system and configured to facilitate transfer of purchased items to the user, wherein the fulfillment portion is physically local to the virtual reality showroom system, the fulfillment portion comprising,
a delivery mechanism configured to deliver the purchased items to a pickup area, wherein the delivery mechanism includes one or more of a conveyor belt, an autonomous vehicle, a pulley system, and a chute system.

2. The virtual reality shopping system of claim 1, further comprising a noise cancellation device.

3. The virtual reality shopping system of claim 2, wherein the noise cancellation device includes one or more of passive noise cancellation devices and active noise cancellation devices.

4. The virtual reality shopping system of claim 1, wherein the virtual reality shopping system includes a second fulfillment portion that is physically remote from the virtual reality showroom system, and wherein the second fulfillment portion is further configured to coordinate shipping of the purchased items to one or more of a retail location, a locker, a residence, and a workplace.

5. The virtual reality shopping system of claim 1, wherein the user input device includes one or more of a touch sensitive device, a mobile device, a pointing device, a keyboard, a microphone, an eye tracking device, a motion tracking device, and a camera.

6. The virtual reality shopping system of claim 1, wherein the user input device comprises a haptic device.

7. The virtual reality shopping system of claim 1, wherein the display device is configured to present a background consistent with a product being viewed in the virtual reality shopping station.

8. The virtual reality shopping system of claim 1, wherein the one or more virtual reality shopping stations include authentication devices configured to authenticate the user to operate the virtual reality showroom system.

9. The virtual reality shopping system of claim 1, wherein the one or more virtual reality shopping stations include payment devices.

10. The virtual reality shopping system of claim 1, wherein the at least a portion of the user is at least 270 degrees.

11. The virtual reality shopping system of claim 1, wherein the one or more virtual reality shopping stations include chairs that can one or more of move and rotate within the one or more virtual reality shopping stations.

12. A method comprising:
providing a virtual reality showroom including one or more virtual reality shopping stations, wherein each of the one or more virtual reality shopping stations include a display device that extends around at least a portion of a user and a user input device;
presenting, via the display device, a visual representation of a shopping space for user navigation;
receiving, via the user input device, user input to allow the user to navigate the virtual representation of the shopping space; and
facilitating, via a fulfillment portion, transfer of purchased items to the user, wherein the fulfillment portion is physically local to the virtual reality showroom system, wherein the fulfillment portion includes a delivery mechanism configured to deliver the purchased items to a pickup area, and wherein the delivery mechanism includes one or more of a conveyor belt, an autonomous vehicle, a pulley system, and a chute system.

13. The method of claim 12, further comprising:
suppressing, by a noise cancellation device, audio.

14. The method of claim 13, wherein the noise cancellation device includes one or more of active noise cancellation devices and active noise cancellation devices.

15. The method of claim 12, wherein the input device includes one or more of a touch sensitive device, a mobile device, a pointing device, a keyboard, a microphone, an eye tracking device, a motion tracking device, and a camera.

16. The method of claim 12, further comprising:
presenting, via the display device, a background consistent with a product being viewed in the virtual reality shopping station.

17. The method of claim 12, wherein the one or more virtual reality shopping stations include authentication devices, the method further comprising:
authenticating, via one of the authentication devices, the user to operate one of the one or more virtual reality shopping stations.

18. The method of claim 12, wherein the one or more virtual reality shopping stations include payments devices.

19. The method of claim 12, wherein the at least a portion of the user is 270 degrees.
